(19) United States
(12) Patent Application Publication
(10) Pub. No.: US 2008/0125101 A1
(43) Pub. Date: May 29, 2008

(54) Method, Apparatus and Computer Program Product for Cross Triggering and Detection of Platform Dependent Resources, Features, Actions and Events

(75) Inventors: Balazs Bakos, Torokbalint (HU); Peter Boda, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/462,159

(22) Filed: Aug. 3, 2006

(51) Int. Cl. H04M 3/00

(52) U.S. Cl. 455/418

(57) ABSTRACT

An apparatus for cross triggering and detection of platform dependent actions and events includes a communication element and a processing element. The communication element is configured to establish, at the apparatus, a seamless communication connection with an electronic device, the seamless communication connection providing the electronic device with access to all resources of the apparatus. The processing element is configured to receive, via the seamless communication connection, an instruction defining an operation to be performed in response to a particular stimulus and to perform the operation in response to the stimulus.

### TECHNOLOGICAL FIELD

Embodiments of the present invention relate generally to communications technology and, more particularly, relate to a method, apparatus and computer program product for cross triggering and detection of platform dependent resources and features, such as actions triggered by certain events.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer and convenience to users relates to automating certain device functions, for example, by establishing rules that may govern certain device functionality. For instance, with respect to electronic devices such as mobile terminals including mobile telephones, pagers, PDAs and other similar devices that are becoming more and more ubiquitous in the modern world, it may be desirable to have the mobile terminal automatically trigger a particular action or event in response to a particular set of conditions being met. In this regard, certain mobile terminal applications have been developed which enable a user of a mobile terminal to set predefined rules which, when certain predefined conditions are met, may trigger a particular action or event in the mobile terminal. However, given the limited capabilities of the user interface of many mobile terminals, it may be difficult or cumbersome to enter complex rules using the user interface of the mobile terminal.

Accordingly, there may be need to develop a mechanism by which to enable a user of a mobile terminal to seamlessly utilize the more robust and richer user interface capabilities of another device in order to communicate e.g. rules, actions, programs, objects, etc. to a mobile terminal. Additionally, it may be desirable to enable cross triggering or detection of platform dependent events and actions, use resources of other devices, access objects across platforms, etc.

### BRIEF SUMMARY

A method, apparatus and computer program product are therefore provided to enable cross triggering and detection of platform dependent resources, features, capabilities, such as actions and events. In particular, a method, apparatus and computer program product are provided that enable the user of a mobile terminal to use the device's resources e.g. via defining rules or conditions at a device having a robust user interface and having those rules or conditions communicated to the mobile terminal. In this regard, a communications mechanism may be established between the mobile terminal and the device having the robust user interface by which necessary communications may be conducted in order to communicate e.g. executable rules to the mobile terminal. Accordingly, via the establishment of the communications mechanism, the mobile terminal may respond, for example, to context rules involving the mobile terminal, the device having the robust user interface or even other devices in communication with either the mobile terminal or the device having the robust user interface. As such, embodiments of the present invention enable the detection of conditions at one or more devices and the triggering of events or actions at the one or more devices in response to the definition of rules or conditions for precipitation of the actions or events at a single device having a robust user interface. It must be noted that the context rule management case (creation, deployment, sharing, evaluation, execution of rules) is just used as an example through the current application to highlight the benefits and the innovative aspects of seamless cross-platform resource access. Similar examples can be found from other areas as well, such as managing multimedia objects (defining naming conventions, folder structure, etc.), giving access rights to devices in case of proximity, managing and editing objects that require substantial user inputs, e.g. calendar reminders, etc.

In one exemplary embodiment (as pointed above, many example utilizations of the seamless cross-platform resource management can be cited, however for the sake of simplicity and easy comprehensibility we will focus on context rule management), a method of providing cross triggering and detection of platform dependent actions and events is provided. The method includes establishing at a host device a seamless communication connection with an electronic device, receiving, via the seamless communication connection, an instruction defining an operation to be performed in response to a particular stimulus, and performing the operation in response to the stimulus. The seamless communication connection provides the electronic device with access to all resources of the host device.

In another exemplary embodiment, a computer program product for providing cross triggering and detection of platform dependent actions and events is provided. The computer program product includes at least one computer-readable storage medium having computer-readable program code portions stored therein. The computer-readable program code portions include first, second and third executable portions. The first executable portion is for establishing at a host device a seamless communication connection with an electronic device. The seamless communication connection provides the electronic device with access to all resources of the host device. The second executable portion is for receiving, via the seamless communication connection, an instruction defining an operation to be performed in response to a particular stimulus. The third executable portion is for performing the operation in response to the stimulus.

In another exemplary embodiment, an apparatus for providing cross triggering and detection of platform dependent actions and events is provided. The apparatus includes a communication element and a processing element. The communication element is configured to establish, at the apparatus, a seamless communication connection with an electronic device, the seamless communication connection providing the electronic device with access to all resources of the apparatus. The processing element is configured to receive, via the seamless communication connection, an instruction defining an operation to be performed in response to a particular stimulus and to perform the operation in response to the stimulus.

In another exemplary embodiment, a system for providing cross triggering and detection of platform dependent actions and events is provided. The system includes a first device and a second device. The second device is capable of establishing a seamless communication connection with the first device (or vice versa). The seamless communication connection provides the first device with access to all resources of the second device. The first device includes a first processing element configured to define an instruction which defines an operation to be performed in response to a particular stimulus. The second device includes a second processing element configured to receive the instruction from the first device via the seamless communication connection and perform the operation in response to the stimulus.

In another exemplary embodiment, an apparatus for providing cross triggering and detection of platform dependent actions and events is provided. The apparatus includes means for establishing at a host device a seamless communication connection with an electronic device, means for receiving, via the seamless communication connection, an instruction defining an operation to be performed in response to a particular stimulus, and means for performing the operation in response to the stimulus. The seamless communication connection provides the electronic device with access to all resources of the host device.

Embodiments of the invention may provide a method, apparatus and computer program product for advantageous employment in a mobile electronic device environment, such as on a mobile terminal in communication with an electronic device having a more robust user interface capability such as a personal computer (PC) or a remote server. As a result, for example, mobile terminal users may enjoy an improved capability for accessing device-specific resources or defining actions or events that occur based upon conditions defined at least in part at another device such, for example, as a PC at which the conditions, actions and events may be more easily defined, e.g. by having a full and seamless view to all the capabilities of the limited device, all the data on it, e.g. names in contact directory, etc. Additionally, embodiments of the present invention provide a mechanism by which to provide cross triggering of events or actions at a first device based on rules that may be formulated and evaluated from another device.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a system for providing cross triggering and detection of platform dependent actions and events according to an exemplary embodiment of the present invention;

FIG. 4 illustrates a rule list according to an exemplary embodiment of the present invention; and

FIG. 5 is a block diagram according to an exemplary method for providing cross triggering and detection of platform dependent actions and events according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Context rule management is described in detail for exemplary purposes, however, similar other application areas can be cited where cross-platform resource management and access can provide advanced user experience. Such cases may include multimedia object management, defining behavior of specific functionalities of a device (e.g. how the camera of a mobile phone should work, where to save by default photos, how to name them, etc.), any preference-like specifications and their management, security related aspects e.g. by defining when and how proximity of two devices should work, and all other case when heavy user input is needed and can be eased by the rich user interface (UI) of another device, e.g. editing to do lists, calendar reminders via the PC's UI while the object being edited resides on the device, etc. Like reference numerals refer to like elements throughout.

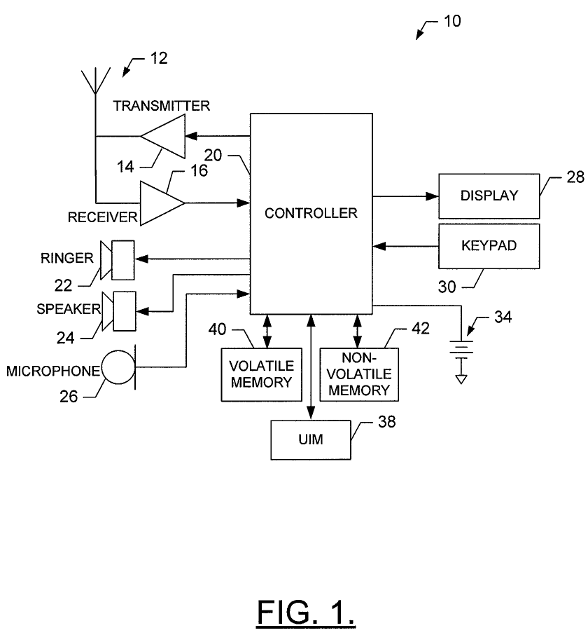

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12, or multiple antennae, in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, and TD-SCDMA.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28 that may also be external display e.g, a TV, a monitor or a LCD projector, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output or any other UI modalities and their combinations (the multimodal approach).

The mobile terminal 10 may further include a universal identity element (UIM) 38. The UIM 38 is typically a memory device having a processor built in. The UIM 38 may include, for example, a subscriber identity element (SIM), a universal integrated circuit card (UICC), a universal subscriber identity element (USIM), a removable user identity element (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

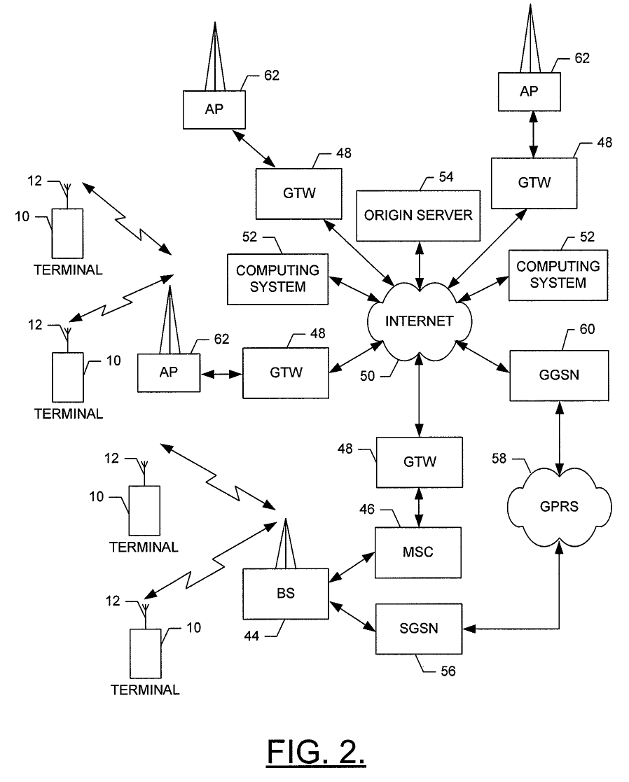

Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

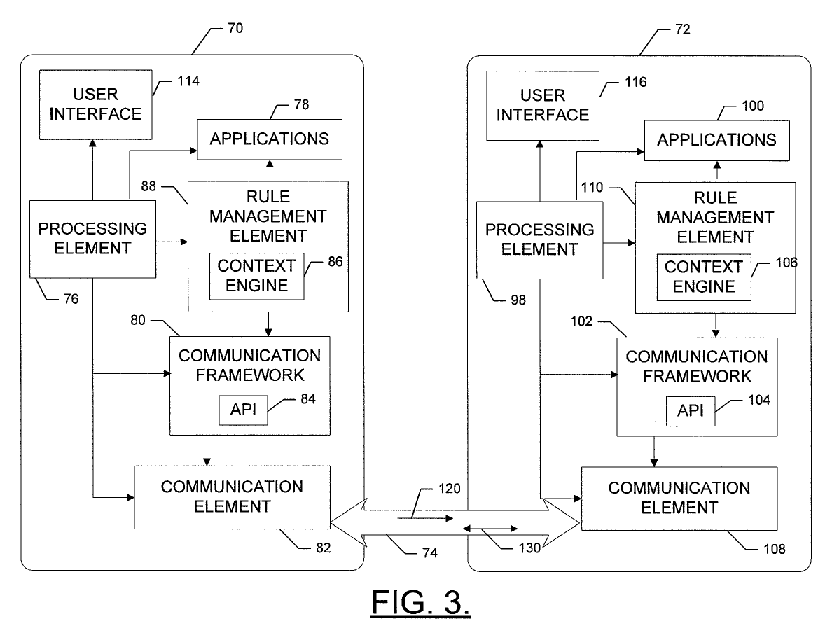

An exemplary embodiment of the invention will now be described with reference to FIG. 3, in which certain elements of a system for providing cross triggering and detection of platform dependent actions and events are shown in greater detail. Once again, this is just used to explain the underlying process of the invention, how cross-platform access of device specific resources is implemented. The system includes a first device 70 and a second device 72. The first and second devices 70 and 72 may each be any electronic device capable of either wireless or wired communication with other electronic devices. In an exemplary embodiment, the second device 72 may be a mobile terminal such as the mobile terminal 10 of FIGS. 1 and 2 while the first device 70 may be the computing system 52 such as a personal computer (PC) or the origin server 54 of FIG. 2. In this regard, according to one exemplary embodiment, it should be understood that the first device 70 is a device having a more robust and richer user interface than that of the second device 72. However, it should be noted that embodiments of the invention are also applicable among devices having substantially similar capabilities and user interfaces. This is typically the case when rules are to be shared among similar devices. As such, either of the first or second devices 70 or 72 may be, for example, a personal or handheld computer, a pager, a PDA, a mobile telephone, a gaming device, a camera, a video recorder, a remote server, etc.

It should be noted that while FIG. 3 illustrates merely one example of a configuration of a system for providing cross triggering and detection of platform dependent actions and events, applications, programs, etc., numerous other configurations may also be used to implement embodiments of the present invention. Additionally, as stated above, it should be noted that the system of FIG. 3, may also be employed in connection with a variety of devices, both mobile and fixed, and therefore, embodiments of the present invention should not be limited to application on devices such as those shown in FIGS. 1 and 2. In an exemplary embodiment, as shown in FIG. 3, an application at each of the first and second devices 70 and 72 may operate under the control of a local processing element in order to execute instructions for performing embodiments of the present invention. However, each of the elements of FIG. 3 may alternatively operate under the control of a processing element of another device not shown in FIG. 3. A processing element such as those described above may be embodied in many ways. For example, the processing element may be embodied as a processor, a coprocessor, a controller or various other processing means or devices including integrated circuits such as, for example, an ASIC (application specific integrated circuit).

Referring now to FIG. 3, a system for providing cross triggering and detection of platform dependent actions and events according to an exemplary embodiment of the present invention includes the first and second devices 70 and 72, which are capable of communication with each other via a wired or wireless connection such as, for example, the communication connection 74 shown in FIG. 3. The communication connection 74 may be either continuous or intermittent. For example, the communication connection 74 may be an internet protocol (IP), Bluetooth, WLAN, wired, etc. connection that is established whenever the first and second devices 70 and 72 are in proximity to each other or manually linked. For exemplary purposes only, the first device 70 of FIG. 3 will be described below as being a PC while the second device 72 will be described as being a mobile terminal such as the mobile terminal 10 of FIG. 1, however, it should be understood that these characterizations are merely exemplary. As such, in the context of the present example, the second device 72 may be understood to have limited resources such as memory, battery life, etc. The second device 72 may also be constrained by a limited user interface. For example, the second device 72 may have a small display, a limited keypad via which entry of long or complicated text is difficult, etc. Meanwhile, in the context of the present example, the first device 70 may be understood to have relatively unlimited resources. For example, the first device 70 may be a PC having a relatively large display and the capability of a robust multimodal interface. In other words, the PC may enable easy entry or manipulation of data or content items via, for example, an easy to use cursor such as provided by a mouse, a large keyboard, voice commands, etc. Accordingly, it may be advantageous to employ the first device 70 having the more robust capability with respect to user interface to define rules for application at the second device 72 or perform other actions to trigger events, actions, applications or access resources at the second device 72. In other words, in one exemplary embodiment, the triggering of particular actions or events at one device may be made contingent upon rules established at another device. Additionally, or alternatively, the detection of a condition at one device may cause the occurrence of an event or action at another device in which either device may have been used in formulation of a rule defining the conditions necessary to trigger the occurrence, e.g. unlocking a screen saver by the mobile device on the PC (by detecting the proximity of a “friendly” device of the authorized user). Finally, as another alternative, the detection of conditions at a combination of a first and second device may trigger the occurrence of an event or action at one of the first and second devices in which either the first, the second, or even a third device is used in formulation of a rule defining the conditions necessary to trigger the occurrence.

As shown in FIG. 3, the first device 70 may include a processing element 76, which is capable of controlling the operations of other elements of the first device 70 and capable of accessing instructions and executing corresponding applications 78. The first device 70 may also include a communication framework 80 capable of establishing a seamless connection with another electronic device such as, for example, the first device 70 via a communication element 82. The communication framework 80 may include any device or means embodied in either hardware, software, or a combination of hardware and software that is capable of managing and/or establishing a connection with another device such as the second device 72, for example, via establishment of the communication connection 74 using the communication element 82. The communication framework 80 may include an application programming interface (API) 84 for accessing services associated with the communication framework 80. For example, the API 84 may allow the communication framework 80 to access services for device management, automated device discovery, and security services. Services related to device discovery may include automatically discovering devices with which the first device 70 may be capable of communication. In this regard, the automated discovery services may be capable of scanning a local environment for devices, for example, using a Bluetooth scan. Alternatively, the automated discovery services may enable the communication framework 80 to identify devices with which the first device 70 has previously communicated and, in an exemplary embodiment, the communication framework 80 may determine the capabilities and availability of resources by reading out device-specific resource profiles of other devices in communication with the first device 70 either by querying the other devices, or by referencing known capabilities based, for example, on known information about the other devices based on previous communications with corresponding ones of the other devices. The security services may include managing security functions of the communication framework 80 with respect to other devices.

The communication element 82 may be any device or means embodied in either hardware, software, or a combination of hardware and software that is capable of providing communication between the first device 70 and other communications devices such as the second device 72. In this regard, the communication element 82 may include an ability to establish a seamless communication mechanism with, for example, the second device 72 via the communication connection 74. The communication connection 74 may be, for example, continuous, continuous for so long as the first and second devices 70 and 72 are in proximity, or intermittent in so far as the communication connection 74 is established for a given period of time to facilitate information exchange and then terminated until such time as the communication connection 74 is caused to be reestablished. As stated above, for example, the communication connection 74 may be a wired or wireless connection such as an internet protocol (IP), Bluetooth, WLAN, etc. connection that is established whenever the first and second devices 70 and 72 are in proximity to each other or otherwise automatically or manually linked.

The first device 70 may also include a rule management element 88 which may also be controlled by the processing element 76. The rule management element 88 (or a general interpreter that takes the rules, objects, programs, actions, etc. defined on the other device) may be any device or means embodied in either hardware, software, or a combination of hardware and software that is capable of establishing, modifying, editing, etc. a rule or rules and controlling certain functions of a device associated with the rule management element 88 (i.e., the first device 70). The rule may include a condition or a plurality of conditions which, if met, trigger execution of a corresponding action or event as defined by the rule. In this regard, the rule management element 88 may be in communication with applications or services of the first device 70 such that when conditions for satisfying a particular rule are met, the rule management element 88 may communicate an instruction to a respective application or service for control of certain operations of the first device 70 in accordance with the instruction as specified in the rule. In other words, the rule management element 88 may be capable of accessing or linking to resources of the first device 70. For example, the rule management element 88 may control modes of operation of the first device 70 such as switching to a meeting mode, control power to the first device 70, execute an automatic response such as an SMS message, or control other applications of the first device 70. As another example, if the rule management element 88 determines that all conditions associated with a rule are satisfied and the rule specifies that power should be secured to a display of the first device 70, then the rule management element 88 can access resources at the first device 70 in order to secure power to the display.

The rule management element 88 may also include a context engine 86. The context engine 86 may be any device or means embodied in either hardware, software, or a combination of hardware and software that is capable of repeatedly or continuously scanning to determine whether particular conditions relative to a context of the first device 70 are met. For example, the context engine 86 may monitor resources of the first device 70 to signal the rule management element 88 when the first device 70 is within proximity to other devices. The context engine 86 may be any context engine known in the art and is therefore capable of informing the rule management element 88 of any other context related information such as is known in the art.

It is also possible that the first device 70 may include a simulation and validation element that is capable of simulating how the second device 72 would react to certain rules with certain conditions. In this way, defined rules can be tested and experimented. Similarly it may also be possible that the first device 70 is capable of testing the defined rule with the second device 72 instantly whenever the rule is generated or modified. In this way, the first device 70 can make sure that the generated rule will work on the second device 72, thereby reducing the possibility of failure in real life operation.

The second device 72 may include elements substantially similar to those of the first device 70. For example, the second device 72 may include a processing element 98 for executing various applications 100. The processing element 98 may also control a communication framework 102 having an API 104 and a communication element 108. Each of the elements above of the second device 72 may include functionality substantially similar to that described above for corresponding elements of the first device 70 and thus, a detailed description of the corresponding elements will not be provided.

The second device 72 may also include a rule management element 110 that is controlled by the processing element 98 of the second device 72. The rule management element 110 may be any device or means embodied in either hardware, software, or a combination of hardware and software that is capable of establishing, modifying, editing, etc. rules and controlling certain functions of the second device 72. The rules may include a condition or a plurality of conditions which, if met, trigger execution of a corresponding action or event as defined by the rule. In this regard, the rule management element 108 may include context engine 106 similar to that described above in regard to the first device 70 such that when conditions for satisfying a particular rule are met, the rule management element 110 may communicate with respective applications or otherwise control certain operations of the second device 72 in accordance with instructions from the rule management element 110 as specified according to the rule.

As stated above, in one exemplary embodiment, the first device 70 may include a relatively robust user interface 114, while the second device 72 may include a relatively limited user interface 116. Accordingly, in an embodiment in which a user is associated with both the first and second devices 70 and 72 such as, for example, the user is the owner of a PC (i.e. the first device 70) and a mobile terminal (i.e., the second device 72) the user may employ the relatively robust user interface 114 of the first device 70 to create rules at the first device 70 which may then be communicated to the second device 72 via the communication connection 74. Since rule generation and other actions to specify particular responses for certain stimuli may be complex, the size of the user interface of the device used to generate such rules or specify such actions may have a substantial impact on the ease or ability to perform such tasks. For example, a complex rule generation would likely not lend itself well to use with a mobile terminal having a limited screen size. As such, in an exemplary embodiment in which rule generation is being performed, it may be desirable to use the relatively robust user interface 114 of the first device 70 in order to provide input from the user to the rule management element 88 of the first device 70 in order to create a rule 120 which may then be communicated via the communication connection 74 from the communication element 82 of the first device 70 to the communication element 108 of the second device 72. The rule 120 may include conditions which, when satisfied, trigger the execution of a particular action or event at a specified device. The rule management element 110 may monitor for satisfaction of the conditions of the rule 120 and in response to satisfaction of all conditions relating to the rule 120 the rule management element 110 may control services or operations of the second device 72 as specified according to actions defined in the rule 120. In an exemplary embodiment, the conditions are context related conditions.

It should be noted that the first device 70 may establish and manage a plurality of rules, which may be associated with the second device 72 or other devices. As such, the rule 120 may include at least one condition and an action which is to be taken in response to satisfaction of the rule. It should be noted that the rule is satisfied when conditions necessary for satisfaction of the rule are met or satisfied. In this regard, the rule 120 may be stated in an IF/THEN format. In other words, the rule 120 may be stated such that the user interface provides the user with an IF field or fields for entry of a condition or conditions which, if met or satisfied, will trigger a corresponding action or actions defined in a THEN field. For example, in a simple rule, the first device 70 may be used to establish a rule that IF Joe is calling (i.e., the condition) THEN send an SMS message to Joe stating “Hi Joe” (i.e., the action). The rule 120 may be made more complex by adding additional conditions, or additional actions. For example, temporal conditions or contextual conditions may be added, or Boolean operators may be inserted between each of multiple conditions. In this regard, the Boolean operators may be simple operators such as AND and OR, or they may be more complex such as XOR and XNOR. For example, the exemplary rule above may be modified such that IF Joe is calling on a Monday OR IF Joe is calling on a Tuesday, THEN send Joe and SMS message stating “Hi Joe”. As stated above, rules involving contextual conditions may also be defined. The context engines 86 and 106 may be capable of monitoring context related information for their respective devices. For example, the context engines 86 and 106 may be capable of determining when other devices, buildings, or individuals are in proximity to their respective devices, an operational mode of their respective devices, a location their respective devices, etc. Accordingly, when the context engines 86 and 106 determine that a particular context condition is satisfied, satisfaction of the context condition may be indicated with respect to each rule having the particular context condition.

In one embodiment, the user interface may include conditions listed on one side and actions listed on the opposite side of the display. In this regard, the user interface may include a portion in which the current rule is displayed in IF/THEN format, and a portion of the display in which a section for modifying or defining conditions related to the rule is displayed, and another portion of the display in which a section for modifying or defining actions related to the rule are displayed. The section for modifying or defining conditions may include a menu item or other object, the selection of which will enable the user to define an additional condition and select a corresponding Boolean operation to be performed with respect to the additional condition. Accordingly, the rule 120 or a plurality of rules, may be defined for the second device 72 at the first device 70 which includes the relatively robust user interface 114.

It should be noted that although this exemplary embodiment has been described in terms of establishing a rule at the first device 70 for monitoring and, in response to satisfaction of conditions associated with the rule, action at the second device 72, this is merely a simple example of a use case associated with an embodiment of the present invention. In more complex examples, embodiments of the present invention may be further capable of, for example, defining a rule at the first device 70, monitoring conditions at the second device 72, and executing an event at a third device which may be one of the mobile terminals 10 listed in FIG. 2, for example. In this regard, the first, second and third devices may each be associated with the user in order to ensure that security concerns do not arise. However, in certain situations in which users of the first, second and third devices are not all the same, it may be possible for security services to be employed by the communication frameworks of each corresponding device to authenticate that each corresponding device is authorized to send rules or condition related information to each other corresponding device. For example, a company or an employer may operate the first device 70 and employees may operate the second device 72 and numerous other devices such as the third device. In this regard, the company may establish an internal WLAN or other communication network in which each device is capable of seamless connection to each other and configured to have security settings which allow respective other devices to communicate rules and/or condition related information to some or each of the other devices. Alternatively, the company may configure the system to allow the first device 72 alone to communicate rules to other devices, while all devices are enabled to communicate condition related information. A similar system could be established, for example, in a user's home. As such, the user's PC could be used to establish rules to be communicated to one or numerous external devices which may be operated pursuant to the rules when corresponding conditions are satisfied. For example, a user may carry two mobile terminals, with one being for personal use and the other for business use. As such, the user's PC may be employed to define a rule that IF the business use mobile terminal is receiving a call, THEN the personal mobile terminal should be switched to silent mode. The PC may communicate the rule to each of the mobile terminals and in response to receiving a call at the business use mobile terminal, the business use mobile terminal may communicate satisfaction of the condition to the personal use mobile terminal thereby triggering the personal use mobile terminal to switch to silent mode.

In another exemplary embodiment, one or more home appliances could be placed in communication with the second device 72. In this regard, sensors of the one or more home appliances may communicate with the second device 72 while the first device 70 was previously used to manage rules and actions related to how the sensory information is to be interpreted, and thereafter how instructions are to be communicated to the home appliance. In such an example, a sensor might continuously provide some information, e.g. temperature, to the second device 72 locally. The second device 72 may then make an intelligent decision about the received sensory data and trigger some action on the home appliance. In this regard, the intelligent decision made by the second device 72 may have been predefined at the first device 70, which was used in this example to define the triggering and sensation process in a user-friendly manner.

In this regard, it should be noted that devices may share condition related information 130 via the communication connection 74 such that conditions related to a particular rule may include conditions sensed at or determined relative to a combination of devices. For example, a rule could state that IF the second device 72 is greater than two meters from the first device 70, THEN lock the screen of the first device 70. Another example may be, IF a voice over IP (VoIP) connection is set up on the first device 70 AND the second device 72 is within two meters of the first device 70, THEN route voice input/output of the VoIP connection through a microphone/speaker of the second device 72. In such a situation, the second device 72 may have the rule created at the first device 70 and communicated to the second device 72 via the communication connection 74. After receiving the rule, the context engine 106 of the second device may monitor for proximity information and communicate satisfaction of either of the proximity related conditions above (i.e., whether the second device 72 is greater or less than two meters from the first device 70) to the first device 70 via condition related information 130 transmitted over the communication connection 74. The first device 70, which may also have the rule, may then conduct the respective actions associated with satisfaction of either of the rules.

It should be noted that the communication channel 74 may also be used for the sharing of e.g. objects, programs, applications, resources, rules between devices. For example, it is clear from the description above that the first device 70, which has created the rule 120 in the present example, may share the rule 120 with the second device 72. However, it should also be understood that the second device 72 may share the rule 120 with other devices in a similar fashion. Furthermore, it should be noted that although the rule 120 may be created at the first device 70, the second device 72 or any other device that receives the rule 120 may modify the rule. In this regard, for example, the relatively limited user interface 116 of the second device 72 may be utilized to modify fields of the rule 120 using resources accessible to the second device 72. The relatively limited user interface 116 may be configured such that a field corresponding to each element of the rule 120 (i.e., each condition and action) may be presented with a list of options or pre-typed entries that may be selected by the user of the second device 72. Alternatively, the user could enter text into the field manually. The list of options may be provided, for example, from a contact list, address book or phonebook of the second device 72. Alternatively, the list of options may be provided from conditional information related to other rules. For example, if a rules states that IF Joe is calling, THEN send an SMS message to Joe stating “Hi Joe”, and the second device 72 receives the rule from the first device 70, the second device 72 may use the rule management element 110 to review the rule and modify the rule if desired.

In an exemplary embodiment in which the first and second devices 70 and 72 are both mobile terminals used by separate individuals, it should be understood that the user of the second device 72 can request a copy of a rule or object (such as the preceding rule described above) from the user of the first device 70. The user of the first device 70 may then communicate the rule to the second device 72 via the communication connection 74. Upon receiving the rule, the rule may be stored at the second device 72. The user of the second device 72 may modify the rule as desired using the rule management element 110. For example, the rule may be selected and displayed at the second device 72 for modification. In this regard, due to the limited capabilities of the user interface of the second device 72, it may be desirable to only display one condition at a time to enable the user of the second device 72 to modify each condition separately. Additionally, an option to delete or add new conditions with associated Boolean logic may also be provided. If the user of the second device 72 desires to simply change the condition such that the rule applies to another individual, the user may select the field in which the name “Joe” appears (i.e., for the condition “IF Joe is calling”), and a list of names may be provided that can be substituted for Joe. The list of names may come from a contact list of the second device 72. The user may then select one of the names from the list, or alternatively add a new name and corresponding contact information, and either save the rule as an entirely new rule or in save the rule as a replacement of the previous rule.

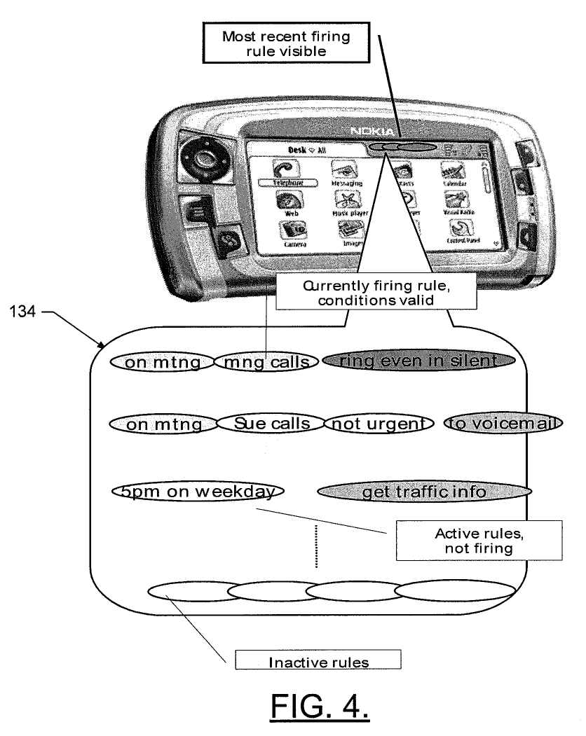

The rule management elements 88 and 110 may also be capable of providing a listing of all rules for display at their respective devices. For example, the rule management element 110 of the second device 72 may enable the second device 72 to display a listing of all rules stored at the second device 72. The listing may be displayed in any suitable order and rules of the listing may be viewed by scrolling through the listing or any other suitable means. In one exemplary embodiment, the listing may be organized in order of most commonly executed rules, or in order of the most recently executed rules. FIG. 4 shows an alternative example of a listing. As shown in FIG. 4, a rule list 134 may be organized in a “currently firing/next to fire” arrangement. In this regard, the “next to fire” designation cannot be precisely predicted, thus a determination as to “next to fire” and ordering based on which rule is likely to fire next may be made based on a percentage of conditions which are currently satisfied. For example, as shown in FIG. 4 a currently firing rule may be displayed first in the rule list 134 while a rule having one out of three conditions currently met or valid may be listed as next to fire ahead of a rule having zero out of one condition met. The rule list 134 may include, for example, color coding of the conditions and actions of each rule in order to indicate a status of each corresponding condition and action. For example, conditions and actions could be displayed in green and blue, respectively. In response to a condition being satisfied, the condition may change color to a darker green, or to an entirely different color such as yellow. In response to all conditions being satisfied for a particular rule, the rule may fire and a color of the firing rule may change, for example, to red or a darker shade of blue. Any combination of color changes may be employed. Alternatively, instead of using colors to indicate the status of conditions and actions for each rule, other mechanisms to indicate status may be employed. For example, an icon may be associated with elements or elements may be displayed within a particular shape in order to identify an element as either a condition or an action. In other words, one shape may correspond to a condition, while another shape may correspond to an action. Changes to properties of the icons or shapes, presence or absence of icons or shapes, or changes from one icon or shape to another may also be used to indicate status. Additionally, each condition may be joined with a particular symbol or other identifier to indicate whether a particular Boolean operation is applicable between the conditions. For example, corresponding symbols for AND and OR may be inserted between conditions depending upon which operation is applicable. In the case of combinations of Boolean operations between elements, brackets, connecting lines or any other suitable means may be employed to illustrate a correct order for employing the Boolean operations in accordance with a rule.

As stated above, the rule 120 may specify a particular action to be performed in response to the rule being satisfied in that each necessary condition of a particular rule is met. In other words, when all of the required conditions of the particular rule have been satisfied, the rule is satisfied and will execute or “fire”. The term “necessary” or “required” condition is meant to refer to conditions which, if met, will trigger execution of the rule in accordance with, for example, the Boolean operations used in defining the rule. For example, if two separate conditions are linked by an AND in defining conditions for the rule, then it is “necessary” that both conditions be met in order for the rule to be satisfied and fire. However, if two separate conditions are linked by an OR in defining conditions for the rule, then it is only “necessary” that one of the two conditions be met in order for the rule to be satisfied and fire. As such, herein wherever it is stated that all conditions are met with respect to a rule, it should be understood that all “necessary” conditions are met to satisfy the rule.

In an exemplary embodiment, the rule management elements 88 and 110 may be configured to provide the latest fired rule for display at the first and second devices 70 and 72, respectively. For example, an edge portion of the display of the respective device may be utilized to display a currently firing rule or most recently fired rule. Accordingly, for example, if a user is in a meeting and receives a call that is sent to voice mail automatically as the result of the operation of a rule, the user may be notified that the rule fired, and thus that a voice mail message is likely waiting for the user. In another embodiment, rules that are active (i.e., rules that currently have at least one condition, but not all conditions satisfied) may be displayed along with firing rules in a first format which displays each element of the rule, while inactive rules (i.e., rules that currently have no conditions satisfied) are displayed in a condensed form such as, for example, only listing the action and not the conditions associated with the rule.

Since, for example, the first device 70 is capable of authoring rules for use at the second device 72, it may be desirable for the first device 70 to be aware of the capabilities of the second device 72 in order to ensure that rules can in fact be executed as contemplated when the rule is authored. For example, if the rule which is authored at the first device 70 defines an action of sending an SMS message from the second device 72 in response to a particular condition being satisfied as determined at the second device 72, then it would be desirable for the first device 70 to have the ability to ascertain whether the capabilities of the second device 72 are sufficient to support sending the SMS message. In a conventional communication connection, it may be possible to access files of one device at another device. However, the communication framework 80 and 102 of embodiments of the present invention is configured to enable, for example, the first device 70 to access all phone resources of the second device 72. Thus, for example, the capabilities of the second device 72 may be extended to the user interface of the first device 70 via the seamless connection. Thus, the first device 70 can determine capabilities of the second device 72 such as whether the second device 72 is capable of sending an SMS message, the battery status of the second device 72, which numbers have called the second device 72, etc. by accessing corresponding resources at the second device 72. Since security concerns may exist between different users, security measures may be installed to limit access for different users based on security settings that each user can control. However, if the first and second devices 70 and 72 belong to the same user, security issues may be less concerning. Accordingly, for example, the first device 70 may be in communication with the second device 72 via the communication connection 74 which may be an IP connection. As such, when the user is authoring a rule at the first device 70 including a particular action, the first device 70 may determine, via the IP connection, whether the second device 72 is capable of performing the particular action.

The seamless connection via the communication connection 74 may also enable the first device 70 to cross trigger an action to be performed at the second device 72 that is specified in a rule of the first device 70. As stated above, the capabilities of the second device 72 may be extended to the first device 70 via the seamless connection. Thus, in practice, via the ability to access resources at the second device 72, the first device 70 may trigger actions to be performed at the second device 72 or vice versa. In other words, in an exemplary embodiment, the first device 70 may be used to author e.g. a rule that is communicated to the second device 72. The second device 72 may monitor conditions and when it is determined that the rule has been satisfied the second device 72 may perform an operation which could include performing the action specified in the rule at the second device 72, triggering performance of the action specified in the rule at the first device 70 or another device, communicating satisfaction of the condition to the first device 70 or another device, or a combination of the preceding.

Although the preceding example has been described in terms of the first device 70 having an open communication established with the second device 72 via the communication connection 74 such that during authoring of a rule, the first device 70 may determine whether the second device 72 can perform a particular action defined in the rule, it is not necessary for open communication to exist during rule authoring. For example, the rule 120 could be authored at the first device 70 while the first device 70 is not in communication with the second device 72. At some later time, the communication connection 74 may be established between the first and second devices 70 and 72 via corresponding communication elements 82 and 108, respectively. When the communication connection 74 is established, the first device 70 may determine the capabilities of the second device 72 with respect to the rule 120 prior to communicating the rule 120 to the second device 72. In this way, the second device 72 may be prevented from consuming resources for storing a rule and monitoring condition satisfaction for a rule that cannot be executed when the conditions are satisfied.

It should be noted, however, that a determination regarding the capabilities of the second device 72 is not required. Furthermore, the first device 70 may be aware of certain capabilities of the second device 72 based on past communications with the second device 72. Accordingly, for example, the first device 70 may communicate a rule to the second device 72 in which the rule includes an action of sending an SMS message without determining the capabilities of the second device 72 if the first device 70 has previously received an SMS message from the second device 72 or if the first device 70 has previously sent rules including actions of sending SMS messages in the past. However, if a rule is communicated to the second device 72 and the second device is incapable of performing the rule or has another rule that operates to conflict with the rule, the second device 72 may be notified of a failure to execute a particular rule and corresponding reasons for the failure. As such, the second device 72 may be employed to modify the rule, the rule may automatically be deleted, or the rule could be returned to the first device 70 with an indication as to why the rule failed to execute.

In an exemplary embodiment, the seamless communication connection 74 provides automatic validation that that, for example, the second device 72 is capable of providing the desired response with regard to a particular condition, rule, action, application, object, etc. In this regard, since the first device 70 can access all of the files, folders, capabilities, applications, etc. of the second device 72, the first device 70 can automatically check to determine the validity of a particular condition, rule, action, etc. that is being defined at the first device 70 for implementation at the second device 72. As such, in the context of rule definition, the first device 70 can immediately check, based on the second device's capabilities 72 whether a rule being defined for the second device 72 is actually valid or correct both semantically and syntactically. Additionally, since the first device 70 can determine the capabilities of the second device 72 automatically and seamlessly via the communication connection 74, the processing element 76 of the first device 70 may dynamically alter the possible choices for making rules for implementation at the second device 72 based on determined capabilities of the second device 72. For example, if a particular rule is desired to be defined at the first device 70 which states that “IF Joe calls AND my phone (i.e., the second device 72) is in silent mode, THEN send Joe an ‘I am busy’ SMS”, then the first device 70 could, during rule definition, determine the capabilities and contents of the second device 72 and provide corresponding information as options for rule generation. Thus, the first device 70 may access the contact list of the second device 72 and, if Joe is in the contact list, then Joe would be provided as an option for selection of the caller whose call may trigger execution of the action to be defined in the rule. Additionally, the first device 70 can automatically determine that the second device 72 has a silent mode and provide the situation where the second device 72 is in the silent mode as an option for selection to define an additional condition for further defining the rule. Finally, the first device 70 may automatically determine that the second device 72 has the ability to send SMS messages and therefore provide sending an SMS as an option for defining the action to be performed in the event of rule satisfaction.

As a result, cross triggering and detection of platform dependent resources, objects, programs, features, actions and events may be accomplished via a seamless connection permitting one device to establish rules for another device.

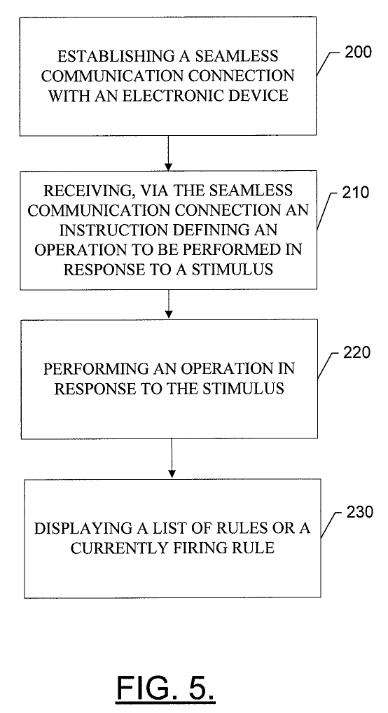

FIG. 5 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing cross triggering and detection of platform related resources, actions and events includes establishing, at a host device, a seamless communication connection with an electronic device at operation 200. The seamless communication connection provides the electronic device with access to all resources of the host device. The seamless communication connection could be a proximity based wireless connection such as, for example, WLAN, Bluetooth, UWB, etc., or a cable based connection such as USB, or any cellular communication connection such as, for example, GPRS, 3G, etc. At operation 210, an instruction is received via the seamless communication connection. The instruction defines an operation to be performed in response to a particular stimulus. In an exemplary embodiment operation 210 may include receiving a rule comprising at least one context related condition and corresponding action to be performed in response to satisfaction of the rule. In this regard, context related information may be monitored to determine whether the rule or corresponding conditions associated with the rule have been satisfied and the stimulus could be satisfaction of the rule or satisfaction of the at least one context related condition. The rule may be received subsequent to a verification that the action associated with the rule is capable of execution. The rule may either be modified or shared with another device. The operation may be performed in response to the stimulus at operation 220. The operation may include performing the action specified in the rule if the rule is satisfied, triggering performance of the action to be specified at another device if the rule is satisfied, or communicating condition related information indicating that the at least one context related condition has been satisfied to another device. At optional operation 230, either a currently firing rule or a list of rules may be displayed. The list of rules may be arranged according to frequency of operation of the rules, likelihood of operation of the rules (which may be based on a percentage of conditions currently met), or time of execution of the rules.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed with the exemplary case of context rule management and that modifications and other embodiments are intended to be included within the scope of the appended claims. Although specific terms are employed herein, they are used in a generic and descriptive sense only and not for purposes of limitation.

What is claimed is:

1. A method comprising:
establishing at a host device a seamless communication connection with an electronic device, the seamless communication connection providing the electronic device with access to all resources of the host device;
receiving, via the seamless communication connection, an instruction defining an operation to be performed in response to a particular stimulus; and
performing the operation in response to the stimulus.

2. A method according to claim 1, wherein receiving the instruction comprises receiving a rule comprising at least one context related condition and a corresponding action to be performed in response to satisfaction of the rule.

3. A method according to claim 2, wherein the stimulus comprises satisfaction of the rule and performing the operation comprises performing the action specified in the rule if the rule is satisfied.

4. A method according to claim 2, wherein the stimulus comprises satisfaction of the rule and performing the operation comprises triggering another device to perform the action specified in the rule if the rule is satisfied.

5. A method according to claim 2, wherein the stimulus comprises satisfaction of the at least one context related condition and performing the operation comprises communicating that the at least one context related condition is satisfied to another device.

6. A method according to claim 2, further comprising displaying a currently firing rule.

7. A method according to claim 2, further comprising displaying a list of rules.

8. A method according to claim 7, wherein displaying the list of rules comprises at least one of:
displaying the list according to frequency of execution of the rules;
displaying the list according to time of execution of the rules; or
displaying the list according to a likelihood of execution of the rules.

9. A method according to claim 2, wherein determining if the at least one context related condition is satisfied comprises monitoring context related information.

10. A method according to claim 1, wherein receiving the instruction comprises receiving the instruction subsequent to a verification that the operation associated with the instruction is capable of execution.

11. A method according to claim 1, further comprising sharing the instruction with another device.

12. A method according to claim 1, further comprising enabling the electronic device to utilize the access to all resources of the host device to receive options for defining the instruction.

13. A computer program product comprising at least one computer-readable storage medium having computer-readable program code portions stored therein, the computer-readable program code portions comprising:
a first executable portion establishing at a host device a seamless communication connection with an electronic device, the seamless communication connection providing the electronic device with access to all resources of the host device;
a second executable portion for receiving, via the seamless communication connection, an instruction defining an operation to be performed in response to a particular stimulus; and
a third executable portion for performing the operation in response to the stimulus.

14. A computer program product according to claim 13, wherein the second executable portion includes instructions for receiving a rule comprising at least one context related condition and corresponding action to be performed in response to satisfaction of the rule, the rule being predefined at the electronic device.

15. A computer program product according to claim 13, wherein the stimulus comprises satisfaction of the rule and the third executable portion includes instructions for one of:
performing the action specified in the rule if the rule is satisfied;
triggering another device to perform the action specified in the rule if the rule is satisfied; or
communicating that the at least one context related condition is satisfied to another device.

16. A computer program product according to claim 14, further comprising a fourth executable portion for displaying a list of rules.

17. A computer program product according to claim 16, wherein the fourth executable portion includes instructions for at least one of:
displaying the list according to frequency of execution of the rules;
displaying the list according to time of execution of the rules; or
displaying the list according to a likelihood of execution of the rules.

18. A computer program product according to claim 13, wherein the second executable portion includes instruction for receiving the instruction subsequent to a verification that the operation associated with the instruction is capable of execution.

19. A computer program product according to claim 13, further comprising a fourth executable portion for enabling the electronic device to utilize the access to all resources of the host device to receive options for defining the instruction.

20. An apparatus comprising:
a communication element configured to establish, at the apparatus, a seamless communication connection with an electronic device, the seamless communication connection providing the electronic device with access to all resources of the apparatus; and
a processing element configured to receive, via the seamless communication connection, an instruction defining an operation to be performed in response to a particular stimulus, and to perform the operation in response to the stimulus.

21. An apparatus according to claim 20, wherein the apparatus further comprises a rule management element, and wherein receiving the instruction comprises to receiving a rule comprising at least one context related condition and corresponding action to be performed in response to satisfaction of the rule, the rule being predefined at the electronic device.

22. An apparatus according to claim 21, wherein the stimulus comprises satisfaction of the rule, and wherein the rule management element is configured to perform the operation comprising performing the action specified in the rule if the rule is satisfied.

23. An apparatus according to claim 21, wherein the stimulus comprises satisfaction of the rule, and wherein the rule management element is configured to perform the operation comprising triggering another device to perform the action specified in the rule if the rule is satisfied.

24. An apparatus according to claim 21, wherein the stimulus comprises satisfaction of the at least one context related condition, and wherein the rule management element is configured to perform the operation comprising communicating that the at least one context related condition is satisfied to another device.

25. An apparatus according to claim 21, wherein the processing element is configured to control the communication element and the rule management element and to display one of a currently firing rule and a list of rules.

26. An apparatus according to claim 25, wherein the processing element is configured to display the list according to at least one of:
a frequency of execution of the rules;
a time of execution of the rules; or
a likelihood of execution of the rules.

27. An apparatus according to claim 21, wherein the rule management element further comprises a context engine configured to monitor context related information associated with the apparatus.

28. An apparatus according to claim 21, wherein the processing element is configured to communicate capabilities of the apparatus to the electronic device such that the rule management element receives the rule subsequent to a verification that the action associated with the rule is capable of execution at the apparatus.

29. An apparatus according to claim 20, wherein the processing element is configured to share the rule with another device.

30. An apparatus according to claim 21, wherein the rule management element is configured to modify the rule.

31. An apparatus according to claim 20, wherein the processing element is configured to enable the electronic device to utilize the access to all resources of the apparatus to receive options for defining the instruction.

32. A system comprising:
a first device; and
a second device capable of establishing a seamless communication connection with the first device, the seamless communication connection providing the first device with access to all resources of the second device,
wherein the first device includes a first processing element configured to define an instruction which defines an operation to be performed in response to a stimulus, and
wherein the second device includes a second processing element configured to:
receive the instruction from the first device via the seamless communication connection; and
perform the operation in response to the stimulus.

33. A system according to claim 32, wherein the first device is configured to utilize the access to all resources of the second device to generate options for defining the instruction.

34. A system according to claim 32, wherein the seamless communication connection is one of:
a proximity based wireless connection;
a cable based connection; or
a cellular communication based connection.

35. An apparatus comprising:
means for establishing at a host device a seamless communication connection with an electronic device, the seamless communication connection providing the electronic device with access to all resources of the host device;
means for receiving, via the seamless communication connection, an instruction defining an operation to be performed in response to a particular stimulus; and
means for performing the operation in response to the stimulus.
